(19) United States
(12) Patent Application Publication
(10) Pub. No.: US 2026/0244929 A1
(43) Pub. Date: Aug. 20, 2026

(54) ERROR CORRECTION AND VERIFICATION IN TRAINING ROBUST ARTIFICIAL INTELLIGENCE/MACHINE MODELS

(71) Applicant: MEDIATEK INC., Hsinchu City (TW)

(72) Inventors: Pedram KHEIRKHAH SANGDEH, San Jose, CA (US); Jie-Ni LIANG, Hsinchu City (TW)

(73) Assignee: MEDIATEK INC., Hsinchu City (TW)

(21) Appl. No.: 19/474,702

(22) PCT Filed: Nov. 13, 2024
(86) PCT No.: PCT/CN2024/131696

§ 371 Date: Oct. 11, 2025

Related U.S. Application Data
(60) Provisional application No. 63/598,156, filed on Nov. 13, 2023.
(60) Provisional application No. 63/598,158, filed on Nov. 13, 2023.

(51) Int. Cl. G06N 3/084; H04L 1/00

(52) U.S. Cl. CPC G06N 3/084; H04L 1/0061

(57) ABSTRACT

Techniques pertaining to error correction and verification in training robust artificial intelligence and machine learning (AI/ML) models in wireless communications are described. An AI/ML model is trained with an intentional error. The trained AI/ML model is then utilized in a user equipment (UE) or a network node of a wireless network.

### CROSS REFERENCE TO RELATED PATENT APPLICATION(S)

The present disclosure claims the priority benefit of U.S. Provisional Patent Applications No. 63/598,156 and 63/598,158, filed 13 Nov. 2023 and 13 Nov. 2023, respectively, the contents of which being herein incorporated by reference in their entirety.

### TECHNICAL FIELD

The present disclosure is generally related to wireless communications and, more particularly, to error correction and verification in training robust artificial intelligence and machine learning (AI/ML) models in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided AI/ML model, also known as autoencoders. For example, for a modulation function at the UE/network there is a demodulation function at the network/UE, for a quantization function at the UE/network there is a dequantization function at the network/UE, for a forward error correction (FEC) encoder at the UE/network there is a decoder at the network/UE, and for a signal shaper function at the UE/network there is a de-shaper at the network/UE, and vice versa. There are also functions/applications that need complimentary modules at both the UE and network such as, for example, channel state information (CSI) compression, denoising (or noise reduction), quantization, coding, error correction codes, modulation, peak-to-average power ratio (PAPR) reduction, and image compression. In short, in a two-sided AI/ML model, it is most ideal to train both sides together so that the function on one side is compatible with the corresponding function on the other side.

In the AI/ML context, a receptive field (RF) expands rapidly or exponentially to an entire input, depending on the number of layers. In a convolutional neural network (CNN) model, with an output from a previous layer taken as input, the receptive field can expand rapidly from an input layer to one intermediate layer and to the subsequent intermediate layer. It thus would be helpful to capture local dependency for the CNN model. In a transformer model with two intermediate layers, there can be a global receptive field even with one layer. That is, each element on a subsequent layer can be impacted by all the elements on a previous layer, and the elements on the subsequent layer tend to share some common information from the previous layer. It thus would be good to capture local and far dependency for the transformer model. In a deep neural network (DNN) model, similarly, there can be a global receptive field even with one layer. It thus would be good to capture local and far dependency for the DNN model.

In many practical cases, input elements also have inter-dependency. That is, some of the input elements may reveal information about other elements. Some real-world examples include, for instance, translation (e.g., it is cloudy today and it is about to rain), auto-correction, and annotation. Accordingly, information on missing or corrupted elements can be corrected using information from uncorrupted elements. In applications in the wireless communications context, such as CSI compression and CSI prediction, when an input passes through two layers of mesh learning models (e.g., one layer of transformer model or CNN model and then another layer of DNN model), very likely there tends to be a global receptive field (and less likely a local receptive field). All latent/output elements are being affected by entire input elements, and each latent element in two-sided AI/ML models or each output element in one-sided AI/ML models may provide information about other elements in the same space. Consequently, any error in the latent space or input space negatively impacts the output. For instance, with an error in the latent space (e.g., error in the transmission medium), with the error occurring during CSI feedback, the input to a network decoder would not be the same as the output of a user equipment (UE) encoder, and the error in the latent space alters the expected input of decoder and inevitably impacts the task of the decoder. As another example, in the input space, with an error occurring before data is fed to an AI/ML model (e.g., error in the transmission medium and/or storage), the error alters the nominal input of the AI/ML model and inevitably impacts the AI/ML task. Therefore, there is a need for a solution of error correction and verification in training robust AI/ML models in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to error correction and verification in training robust AI/ML models in wireless communications. It is believed that implementations of the various proposed schemes may address or otherwise alleviate the aforementioned issue(s). The various schemes proposed herein may be utilized in a variety of applications and scenarios such as, for example and without limitation, CSI compression, denoising (or noise reduction), quantization, coding, error correction codes, modulation, peak-to-average power ratio (PAPR) reduction, and image compression.

In one aspect, a method may involve training an AI/ML model with an intentional error. The method may also involve the processor utilizing the trained AI/ML model in a user equipment (UE) or a network node of a wireless network.

It is noteworthy that, although description provided herein may be in the context of certain radio access technologies, networks, and network topologies for wireless communication, such as 5^{th} Generation (5G)/New Radio (NR)/ 6^{th} Generation (6G) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a block diagram of an example communication system under a proposed scheme in accordance with the present disclosure.

FIG. 9 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to error correction and verification in training robust AI/ML models in wireless communications. According to the present disclosure, a number of possible solutions may be implemented separately or jointly. That is, although these possible solutions may be described below separately, two or more of these possible solutions may be implemented in one combination or another.

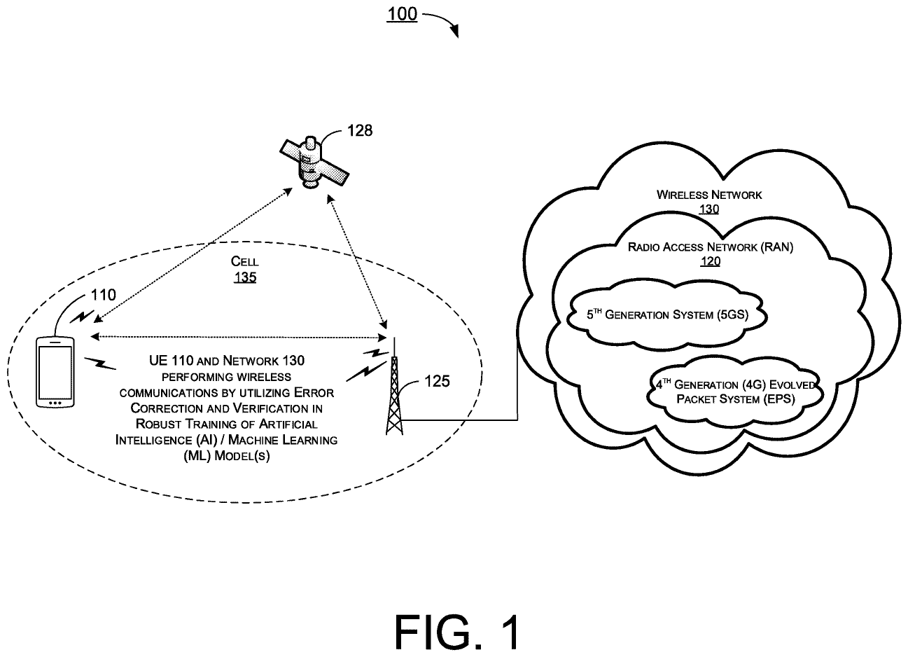

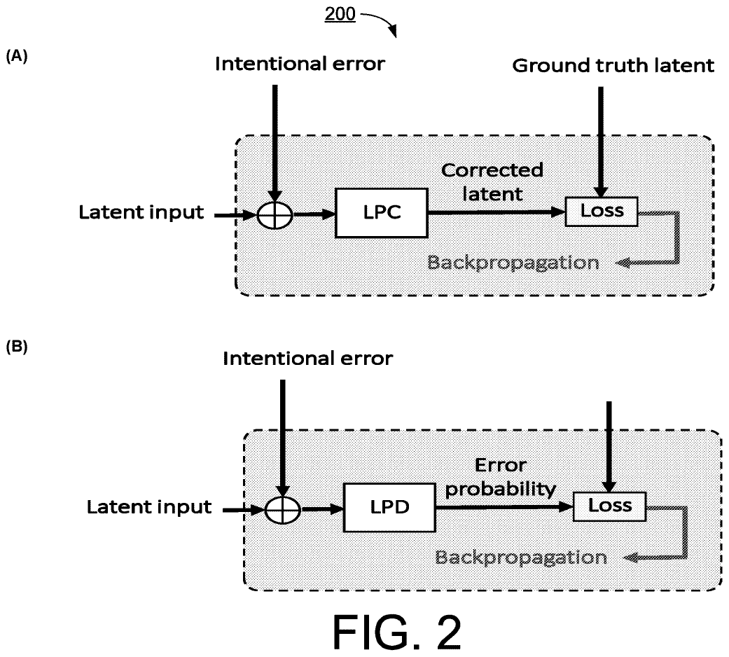

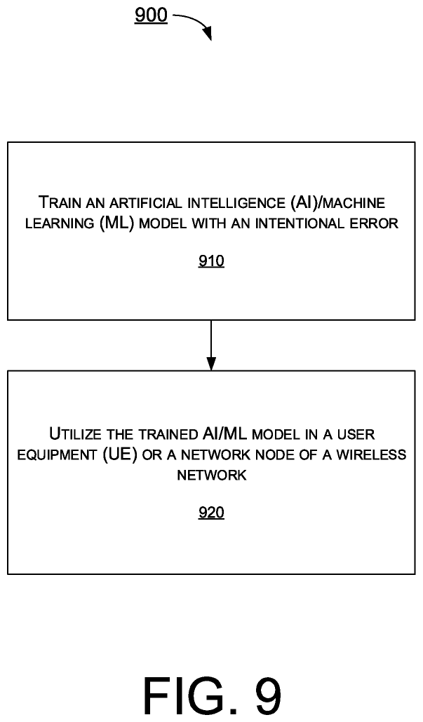

FIG. 1 illustrates an example network environment 100 in which various solutions and schemes in accordance with the present disclosure may be implemented. FIG. 2~FIG. 9 illustrate examples of implementation of various proposed schemes in network environment 100 in accordance with the present disclosure. The following description of various proposed schemes is provided with reference to FIG. 1~FIG. 9.

Referring to FIG. 1, network environment 100 may involve a user equipment (UE) 110 in wireless communication with a radio access network (RAN) 120 (e.g., a 5G NR/ 6 G mobile network, another type of network such as a non-terrestrial network (NTN) or a future-generation network). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a wireless network 130. In network environment 100, UE 110 and wireless network 130 (via terrestrial network node 125 and/or non-terrestrial network node 128) may implement various schemes pertaining to error correction and verification in training robust AI/ML models in wireless communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example design 200 under a proposed scheme in accordance with the present disclosure. Under the proposed scheme, in two-sided AI/ML models, an error corrector or error detector may be utilized to correct or detect an error before the error is fed to a subsequent stage or a receiving side for processing for further actions. The term “pluggable” here refers to the idea that there is no need to change the AI/ML models, and an error corrector (herein interchangeably referred to as a “pluggable corrector”, “lightweight pluggable corrector” or LPC), shown in part (A) of FIG. 2, and/or an error detector (herein interchangeably referred to as a “pluggable detector”, “lightweight pluggable detector” or LPD), shown in part (B) of FIG. 2, may be added or plugged into AI/ML models to improve performance. Referring to part (A) of FIG. 2, an AI/ML model may be trained to map an erroneous latent to a correct latent by utilizing an error corrector during the training. For instance, during the training phase, an intentional error, along with an input or latent input, may be provided to an LPC, which outputs a corrected latent that is compared with a ground truth input or ground truth latent. The result of the comparison may be backpropagated as feedback to train the AI/ML model on error correction, thereby improving performance of the AI/ML model. Referring to part (B) of FIG. 2, an AI/ML model may be trained to map an erroneous latent to a correct latent by utilizing an error detector during the training. For instance, during the training phase, an intentional error, along with an input or latent input, may be provided to an LPD, which outputs a detection result (e.g., an error detection probability or a simple “yes” or “no” regarding error detection) that is compared with the intentional error. The result of the comparison may be backpropagated as feedback to train the AI/ML model on error detection, thereby improving performance of the AI/ML model. Notably, the error corrector may not only detect an error but also fix or otherwise correct the error, while the error detector may only detect an error without fixing or correcting the error.

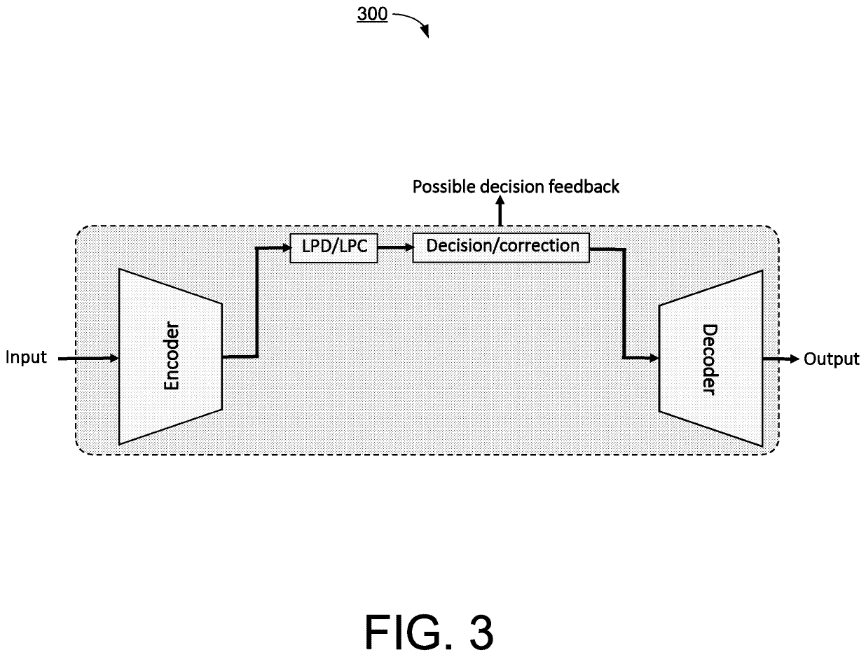

FIG. 3 illustrates an example design 300 under a proposed scheme in accordance with the present disclosure. Design 300 may pertain to utilization of an LPC or LPD in an interference stage of a two-sided AI/ML model. Referring to FIG. 3, an LPD/LPC may be plugged into the inference stage between an encoder (e.g., on a UE side) and a decoder (e.g., on a network side) of a two-sided AI/ML model, with the LPD/LPC detecting or correcting an error and providing a detection decision or correction as a feedback. Advantageously, performance of AI/ML models thus trained may be boosted, especially with error correction by the LPC. Moreover, unnecessary execution of erroneous input may be avoided with error detection by the LPD. Moreover, request retransmission may be carried out upon detection of an error by the LPD/LPC. Furthermore, the utilization of LPD/LPC may go beyond the capability of error correction codes.

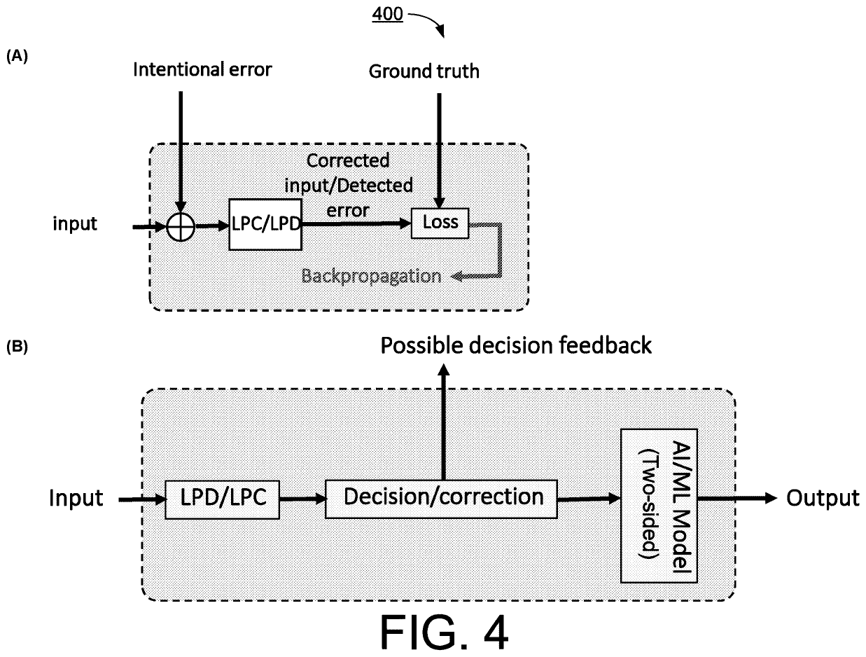

FIG. 4 illustrates an example design 400 under a proposed scheme in accordance with the present disclosure. Design 400 may pertain to utilization of an LPC or LPD in a one-sided AI/ML model. Referring to part (A) of FIG. 4, an LPD or LPC may be applied at the input of a one-sided AI/ML model to train the model to detect or correct errors. Referring to part (B) of FIG. 4, an LPD or LPC may be applied at the inference stage to train the model to detect or correct errors.

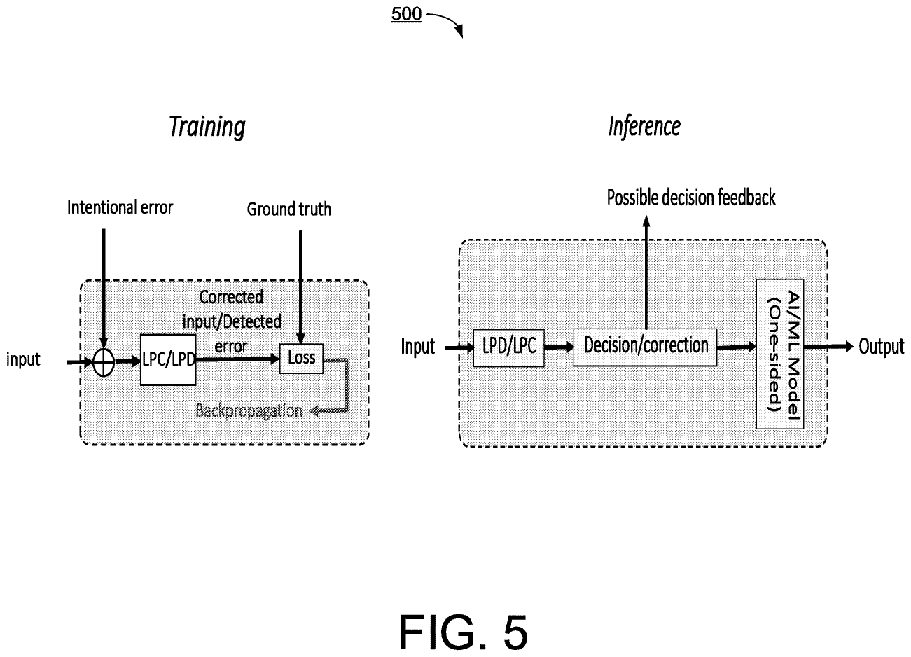

FIG. 5 illustrates an example design 500 under a proposed scheme in accordance with the present disclosure. Design 500 may pertain to utilization of an LPC or LPD in a two-sided AI/ML model. Referring to FIG. 5, considering the two-sided model from an end-to-end perspective, it may be viewed as a single one-sided AI/ML model. Therefore, the LPD/LPC may be applied to two-sided AI/ML models as described above with respect to the one-sided AI/ML model in FIG. 4.

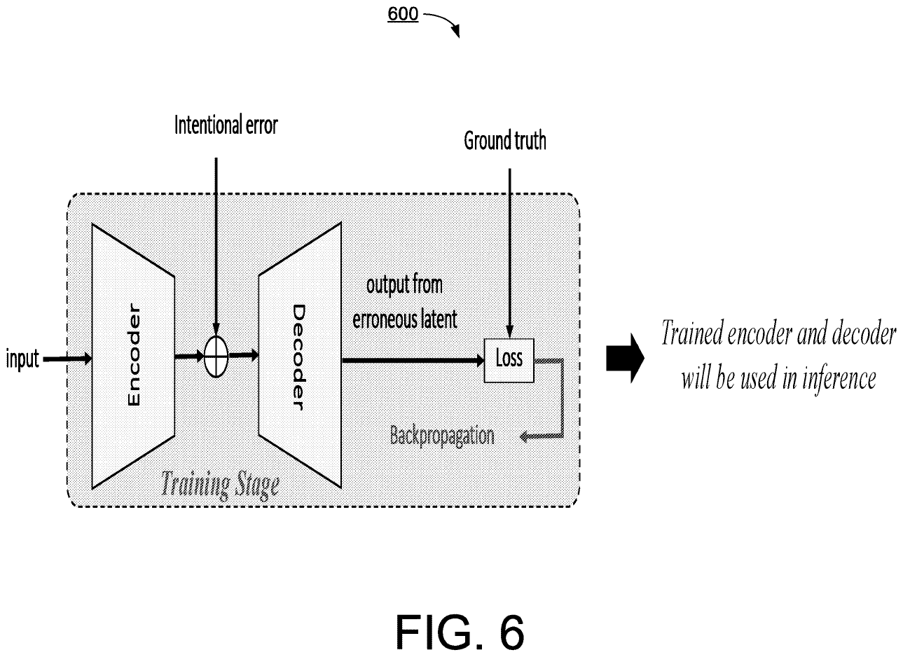

FIG. 6 illustrates an example design 600 under a proposed scheme in accordance with the present disclosure. Design 600 may pertain to training of robust two-sided AI/ML models. Under the proposed scheme, a two-sided AI/ML model in a training stage may be forced to focus on correction of latent elements, thereby exposing the model to intentional errors in the training stage. Referring to FIG. 6, an intentional error may be introduced to an intermediate phase (e.g., to mimic an error in transmission) between an encoder and a decoder, or simply as an input to the decoder. The output from a resultant erroneous latent or input may then be compared with a ground truth input/latent, with a result of the comparison may be backpropagated as feedback to train the AI/ML model on error detection or correction. The trained encoder and decoder may be used in inference. Design 600 may be easily extended to all training types. Additionally, the design may be generalizable to suit any type of error. Moreover, the design may be extendable even to one-sided AI/ML models with intentional error in the input.

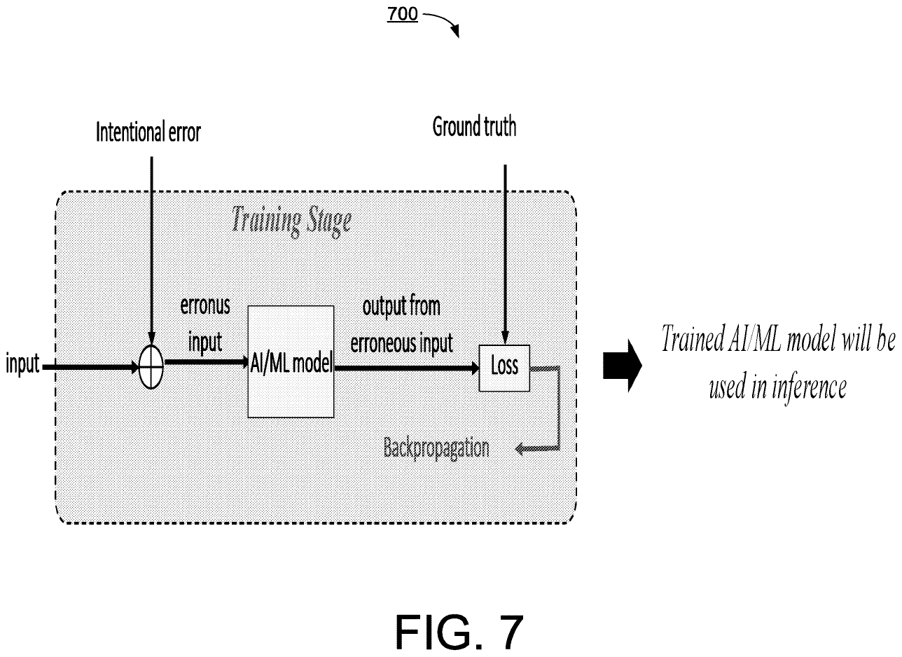

FIG. 7 illustrates an example design 700 under a proposed scheme in accordance with the present disclosure. Design 700 may pertain to training of robust one-sided AI/ML models. Under the proposed scheme, a one-sided AI/ML model in a training stage may be forced to focus on correction of latent elements, thereby exposing the model to intentional errors in the training stage. Referring to FIG. 7, an intentional error may be introduced to an input to result in an erroneous input being provided to the one-sided AI/ML model in training. The output from the model, based on the erroneous input, may then be compared with a ground truth input/latent, with a result of the comparison may be backpropagated as feedback to train the AI/ML model on error detection or correction. The trained AI/ML model may be used in inference. Design 700 may be easily extended to all input types such as, for example, words, images, long texts, values or measurements, and so on. Additionally, the design may be generalizable to suit any type of error.

In view of the above, under some of the above-described proposed schemes, error correction and verification in AI/ML models may involve correlation of input and latent elements of a typical AI/ML model. An LPC may be utilized for latent and input of two-sided AI/ML models and for input of one-sided AI/ML models. Similarly, an LPD may be utilized for latent and input of two-sided AI/ML models and for input of one-sided AI/ML models. Moreover, under some other proposed schemes, robust two-sided AI/ML models as well as robust one-sided AI/ML models may be trained by intentional introduction of errors during the training stage, without utilization of an LPD or LPC. The robust AI/ML models may be implemented in UE 110 and terrestrial network node 125, non-terrestrial network node 128, RAN 120, and wireless network 130

### Illustrative Implementations

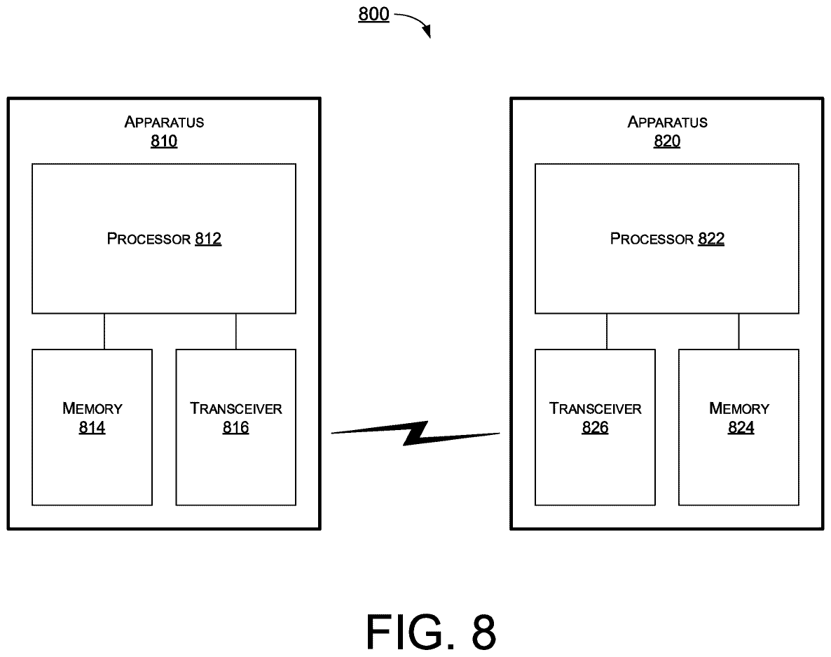

FIG. 8 illustrates an example communication system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 810 and apparatus 820 may be a part of an electronic apparatus, which may be a network apparatus or a UE device (e.g., UE 110), such as a portable or mobile apparatus, a wearable apparatus, a vehicular device or a vehicle, a wireless communication apparatus or a computing apparatus. For instance, each of apparatus 810 and apparatus 820 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in an eNodeB in an LTE, LTE-Advanced or LTE-Advanced Pro network or in a gNB or TRP in a 5G/NR network, a 6G network or an IoT network.

In some implementations, each of apparatus 810 and apparatus 820 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 810 and apparatus 820 may be implemented in or as a network apparatus or a UE. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC or RISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including those pertaining to error correction and verification in training robust AI/ML models in wireless communications in accordance with various implementations of the present disclosure.

In some implementations, apparatus 810 may also include a transceiver 816 coupled to processor 812. Transceiver 816 may be capable of wirelessly transmitting and receiving data. In some implementations, transceiver 816 may be capable of wirelessly communicating with different types of wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs/wireless networks of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a UE device (e.g., UE 110), and apparatus 820, as a network node (e.g., network node 125) of a network (e.g., network 130 as a 5G/NR or 6G mobile network), is provided below in the context of example process 900.

### Illustrative Processes

FIG. 9 illustrates an example process 900 in accordance with an implementation of the present disclosure. Process 900 may represent an aspect of implementing various proposed designs, concepts, schemes, systems and methods described above pertaining to error correction and verification in training robust AI/ML models in wireless communications, whether partially or entirely, including those pertaining to those described above. Process 900 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or alternatively in a different order. Furthermore, one or more of the blocks/sub-blocks of each process may be executed iteratively. Process 900 may be implemented by or in apparatus 810 and/or apparatus 820 as well as any variations thereof. Solely for illustrative purposes and without limiting the scope, each process is described below in the context of apparatus 810 as a UE device (e.g., UE 110) and apparatus 820 as a communication entity such as a network node or base station (e.g., terrestrial network node 120) of a network (e.g., a 5G/NR or 6G mobile network). Process 900 may begin at block 910.

At 910, process 900 may involve processor 812 of apparatus 810 (e.g., as UE 110) training an AI/ML model with an intentional error. Alternatively, or additionally, process 900 may involve processor 822 of apparatus 820 (e.g., as terrestrial network node 125 or non-terrestrial network node 128 of wireless network 130) training the AI/ML model with the intentional error. Process 900 may proceed from 910 to 920.

At 920, process 900 may involve processor 812 utilizing the trained AI/ML model in wireless communications (e.g., with apparatus 820). Alternatively, or additionally, process 900 may involve processor 822 utilizing the trained AI/ML model in wireless communications (e.g., with apparatus 810).

In some implementations, in training the AI/ML model, process 900 may involve processor 812 or processor 822 training the AI/ML model with an error corrector plugged in the AI/ML model to detect and correct the intentional error and an input or latent to produce a corrected input or latent. Moreover, the corrected input or latent may be compared with a ground truth input or latent to provide a backpropagation as a feedback to the AI/ML model.

In some implementations, in training the AI/ML model, process 900 may involve processor 812 or processor 822 training the AI/ML model with an error detector plugged in the AI/ML model to detect the intentional error and an input or latent to produce a detection result. Additionally, the detection result may be compared with the intentional error to provide a backpropagation as a feedback to the AI/ML model.

In some implementations, in training the AI/ML model, process 900 may involve processor 812 or processor 822 training the AI/ML model with an error corrector plugged in an inference stage between an encoder and a decoder of the AI/ML model to produce a corrected latent as a feedback to the AI/ML model.

In some implementations, in training the AI/ML model, process 900 may involve processor 812 or processor 822 training the AI/ML model with an error detector plugged in an inference stage between an encoder and a decoder of the AI/ML model to produce a detection decision as a feedback to the AI/ML model.

In some implementations, in training the AI/ML model, process 900 may involve processor 812 or processor 822 training a one-sided AI/ML model with an error corrector plugged in the one-sided AI/ML model to detect and correct the intentional error and an input to produce a corrected input, which may be compared with a ground truth input to provide a backpropagation as a feedback to the one-sided AI/ML model.

In some implementations, in training the AI/ML model, process 900 may involve processor 812 or processor 822 training a one-sided AI/ML model with an error corrector plugged in an inference stage of the one-sided AI/ML model to produce a corrected input to the one-sided AI/ML model.

In some implementations, in training the AI/ML model, process 900 may involve processor 812 or processor 822 training a one-sided AI/ML model with an error detector plugged in the one-sided AI/ML model to detect the intentional error and an input to produce a detection decision, which may be compared with a ground truth input to provide a backpropagation as a feedback to the one-sided AI/ML model.

In some implementations, in training the AI/ML model, process 900 may involve processor 812 or processor 822 training a one-sided AI/ML model with an error detector plugged in an inference stage of the one-sided AI/ML model to produce an error decision to the one-sided AI/ML model.

In some implementations, in training the AI/ML model, process 900 may involve processor 812 or processor 822 training a two-sided AI/ML model with an error corrector plugged in the two-sided AI/ML model to detect and correct the intentional error and an input to produce a corrected input, which may be compared with a ground truth input to provide a backpropagation as a feedback to the two-sided AI/ML model. In some implementations, in training the AI/ML model, process 900 may further involve processor 812 or processor 822 training the two-sided AI/ML model with the error corrector plugged in an inference stage of the two-sided AI/ML model to produce a correction to the two-sided AI/ML model.

In some implementations, in training the AI/ML model, process 900 may involve processor 812 or processor 822 training a two-sided AI/ML model with an error detector plugged in the two-sided AI/ML model to detect the intentional error with an input to produce a detection decision, which may be compared with a ground truth input to provide a backpropagation as a feedback to the two-sided AI/ML model. In some implementations, in training the AI/ML model, process 900 may further involve processor 812 or processor 822 training the two-sided AI/ML model with the error detector plugged in an inference stage of the two-sided AI/ML model to produce a decision to the two-sided AI/ML model.

In some implementations, in training the AI/ML model, process 900 may involve processor 812 or processor 822 training a two-sided AI/ML model by introducing the intentional error to a latent in a training stage between an encoder and a decoder of the two-sided AI/ML model to produce an output from the decoder based on an erroneous latent. In some implementations, in training the AI/ML model, process 900 may further involve processor 812 or processor 822 comparing the output from the decoder with a ground truth to provide a backpropagation as a feedback to the two-sided AI/ML model.

In some implementations, in training the AI/ML model, process 900 may involve processor 812 or processor 822 training a one-sided AI/ML model by introducing the intentional error and an input together as an erroneous input to the one-sided AI/ML model to produce an output from the erroneous input. In some implementations, in training the AI/ML model, process 900 may further involve processor 812 or processor 822 comparing the output from the one-sided AI/ML model with a ground truth to provide a backpropagation as a feedback to the one-sided AI/ML model.

In some implementations, in utilizing the trained AI/ML model, process 900 may involve processor 812 or processor 822 utilizing the trained AI/ML model in performing CSI compression, noise reduction, quantization, coding, error correction codes, modulation, PAPR reduction, or image compression.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
training an artificial intelligence (AI)/machine learning (ML) model with an intentional error; and
utilizing the trained AI/ML model in a user equipment (UE) or a network node of a wireless network.

2. The method of claim 1, wherein the training of the AI/ML model comprises training the AI/ML model with an error corrector plugged in the AI/ML model to detect and correct the intentional error and an input or latent to produce a corrected input or latent.

3. The method of claim 2, wherein the corrected input or latent is compared with a ground truth input or latent to provide a backpropagation as a feedback to the AI/ML model.

4. The method of claim 1, wherein the training of the AI/ML model comprises training the AI/ML model with an error detector plugged in the AI/ML model to detect the intentional error and an input or latent to produce a detection result.

5. The method of claim 4, wherein the detection result is compared with the intentional error to provide a backpropagation as a feedback to the AI/ML model.

6. The method of claim 1, wherein the training of the AI/ML model comprises training the AI/ML model with an error corrector plugged in an inference stage between an encoder and a decoder of the AI/ML model to produce a corrected latent as a feedback to the AI/ML model.

7. The method of claim 1, wherein the training of the AI/ML model comprises training the AI/ML model with an error detector plugged in an inference stage between an encoder and a decoder of the AI/ML model to produce a detection decision as a feedback to the AI/ML model.

8. The method of claim 1, wherein the training of the AI/ML model comprises training a one-sided AI/ML model with an error corrector plugged in the one-sided AI/ML model to detect and correct the intentional error and an input to produce a corrected input, which is compared with a ground truth input to provide a backpropagation as a feedback to the one-sided AI/ML model.

9. The method of claim 1, wherein the training of the AI/ML model comprises training a one-sided AI/ML model with an error corrector plugged in an inference stage of the one-sided AI/ML model to produce a corrected input to the one-sided AI/ML model.

10. The method of claim 1, wherein the training of the AI/ML model comprises training a one-sided AI/ML model with an error detector plugged in the one-sided AI/ML model to detect the intentional error and an input to produce a detection decision, which is compared with a ground truth input to provide a backpropagation as a feedback to the one-sided AI/ML model.

11. The method of claim 1, wherein the training of the AI/ML model comprises training a one-sided AI/ML model with an error detector plugged in an inference stage of the one-sided AI/ML model to produce an error decision to the one-sided AI/ML model.

12. The method of claim 1, wherein the training of the AI/ML model comprises training a two-sided AI/ML model with an error corrector plugged in the two-sided AI/ML model to detect and correct the intentional error and an input to produce a corrected input, which is compared with a ground truth input to provide a backpropagation as a feedback to the two-sided AI/ML model.

13. The method of claim 12, wherein the training of the AI/ML model further comprises training the two-sided AI/ML model with the error corrector plugged in an inference stage of the two-sided AI/ML model to produce a correction to the two-sided AI/ML model.

14. The method of claim 1, wherein the training of the AI/ML model comprises training a two-sided AI/ML model with an error detector plugged in the two-sided AI/ML model to detect the intentional error with an input to produce a detection decision, which is compared with a ground truth input to provide a backpropagation as a feedback to the two-sided AI/ML model.

15. The method of claim 14, wherein the training of the AI/ML model further comprises training the two-sided AI/ML model with the error detector plugged in an inference stage of the two-sided AI/ML model to produce a decision to the two-sided AI/ML model.

16. The method of claim 1, wherein the training of the AI/ML model comprises training a two-sided AI/ML model by introducing the intentional error to a latent in a training stage between an encoder and a decoder of the two-sided AI/ML model to produce an output from the decoder based on an erroneous latent.

17. The method of claim 16, wherein training further comprises comparing the output from the decoder with a ground truth to provide a backpropagation as a feedback to the two-sided AI/ML model.

18. The method of claim 1, wherein the training of the AI/ML model comprises training a one-sided AI/ML model by introducing the intentional error and an input together as an erroneous input to the one-sided AI/ML model to produce an output from the erroneous input.

19. The method of claim 18, wherein training further comprises comparing the output from the one-sided AI/ML model with a ground truth to provide a backpropagation as a feedback to the one-sided AI/ML model.

20. The method of claim 1, wherein the utilizing of the trained AI/ML model comprises utilizing the trained AI/ML model in performing channel state information (CSI) compression, noise reduction, quantization, coding, error correction codes, modulation, peak-to-average power ratio (PAPR) reduction, or image compression.
